(19) United States
(12) Patent Application Publication
(10) Pub. No.: US 2024/0271481 A1
(43) Pub. Date: Aug. 15, 2024

(54) SEALING DOOR AND SEALING METHOD

(71) Applicant: Xiaojie LIU, Dalian City (CN)

(72) Inventor: Xiaojie LIU, Dalian City (CN)

(73) Assignee: TDK DOORS INC., VANCOUVER (CA)

(21) Appl. No.: 18/632,284

(22) Filed: Apr. 11, 2024

(51) Int. Cl. E06B 7/23; E06B 3/82

(52) U.S. Cl. CPC E06B 7/2312; E06B 3/822

(57) ABSTRACT

The present disclosure discloses a sealing door, including a door plate main body and at least two sealing assemblies, wherein the door plate main body has an upper end surface, a lower end surface, a left end surface, and a right end surface. The sealing assemblies are arranged along surfaces of the end surfaces in a protruding and extending manner. Two adjacent sealing assemblies are spaced apart; and the sealing assemblies are configured to be in contact with an inner surface of a door frame when the sealing door is in a closed state, so as to form a first isolation space between the two adjacent sealing assemblies and the inner surface of the door frame. The present disclosure further discloses a sealing method.

### TECHNICAL FIELD

The present disclosure relates to the technical field of doors and windows, and in particular, to a sealing door and a sealing method.

### BACKGROUND OF THE INVENTION

In daily work and life, people often use doors to isolate environments inside and outside a room. For some special environments, such as a freezer and a dust-free factory, existing products usually cannot provide good sealing and thermal insulation effects, which cannot meet the needs of users.

For this purpose, the present disclosure provides a sealing door and a sealing method, which have a good sealing property and a good thermal insulation property and can effectively solve the above problems. The sealing door is simple in structure and good in sealing and thermal insulation.

### SUMMARY OF THE INVENTION

In order to overcome the shortcomings of the prior art, the present disclosure provides a sealing door and a sealing method. The sealing door is simple in structure and good in sealing and thermal insulation.

The present disclosure provides a sealing door, including:
a door plate main body, wherein the door plate main body has an upper end surface, a lower end surface, a left end surface, and a right end surface; and
at least two sealing assemblies, wherein the sealing assemblies are arranged along surfaces of the upper end surface, the lower end surface, the left end surface, and the right end surface in an extending manner and protrude out of the surfaces of the upper end surface, the lower end surface, the left end surface, and the right end surface; two adjacent sealing assemblies are spaced apart from each other; the sealing assemblies are configured to be in contact with an inner surface of a door frame when the sealing door is in a closed state, so as to form a first isolation space between the two adjacent sealing assemblies and the inner surface of the door frame.

As the improvement of the present disclosure, each sealing assembly is provided with a mounting part and a sealing part; the upper end surface, the lower end surface, the left end surface, and the right end surface are all provided with a mounting slot and an open slot communicated to the mounting slot; the mounting part is inserted into the mounting slot; and the sealing part penetrates through the open slot.

As the improvement of the present disclosure, a width of the mounting part is greater than a width of the sealing part, and the width of the mounting part is greater than a width of the open slot; the width of the open slot is greater than the width of the sealing part; and the mounting part abuts against an inner surface of the mounting slot.

As the improvement of the present disclosure, the door plate main body includes a frame and two panels; the two panels are respectively connected to front and rear surfaces of the frame; and a second isolation space is formed between the two panels and an inner surface of the frame.

As the improvement of the present disclosure, the sealing door further includes a rotating connector, wherein the rotating connector is arranged on one side of the door plate main body close to the left end surface or the right end surface; and the rotating connector is configured to be connected to another rotating connector arranged on the inner surface of the door frame.

As the improvement of the present disclosure, the rotating connector is a rotating shaft; notches are arranged at upper and lower ends of the left end surface or upper and lower ends of the right end surface; and the rotating shaft is arranged inside the notches.

As the improvement of the present disclosure, each notch has a side end surface; at least a part of each sealing assembly is arranged on the side end surface; and the sealing assembly is arranged towards the rotating shaft.

As the improvement of the present disclosure, the at least two sealing assemblies are respectively located on two sides of an axial line where the rotating shaft is located.

As the improvement of the present disclosure, the door plate main body is provided with two rotating arc surfaces close to the rotating shaft; and the two rotating arc surfaces are symmetrically arranged on two sides of the rotating shaft.

As the improvement of the present disclosure, the two panels are both provided with windows; the two windows are arranged opposite to each other; and transparent or semi-transparent shutters are arranged at the windows.

The present disclosure also provides a sealing method, including: providing a sealing door, and mounting the sealing door in a door frame, wherein the sealing door includes:
a door plate main body, wherein the door plate main body has an upper end surface, a lower end surface, a left end surface, and a right end surface; and
at least two sealing assemblies, wherein the sealing assemblies are arranged along surfaces of the upper end surface, the lower end surface, the left end surface, and the right end surface in an extending manner and protrude out of the surfaces of the upper end surface, the lower end surface, the left end surface, and the right end surface; two adjacent sealing assemblies are spaced apart from each other; when the sealing door is closed, the sealing assemblies are in contact with an inner surface of the door frame, so as to form a first isolation space between the two adjacent sealing assemblies and the inner surface of the door frame.

As the improvement of the present disclosure, each sealing assembly is provided with a mounting part and a sealing part; the upper end surface, the lower end surface, the left end surface, and the right end surface are all provided with a mounting slot and an open slot communicated to the mounting slot; the mounting part is inserted into the mounting slot; and the sealing part penetrates through the open slot.

As the improvement of the present disclosure, a width of the mounting part is greater than a width of the sealing part, and the width of the mounting part is greater than a width of the open slot; the width of the open slot is greater than the width of the sealing part; and the mounting part abuts against an inner surface of the mounting slot.

As the improvement of the present disclosure, the door plate main body includes a frame and two panels; the two panels are respectively connected to front and rear surfaces of the frame; and a second isolation space is formed between the two panels and an inner surface of the frame.

As the improvement of the present disclosure, the sealing door further includes a rotating connector; the rotating connector is arranged on one side of the door plate main body close to the left end surface or the right end surface; and the rotating connector is configured to be connected to another rotating connector arranged on the inner surface of the door frame.

As the improvement of the present disclosure, the rotating connector is a rotating shaft; notches are arranged at upper and lower ends of the left end surface or upper and lower ends of the right end surface; and the rotating shaft is arranged inside the notches.

As the improvement of the present disclosure, each notch has a side end surface; at least a part of each sealing assembly is arranged on the side end surface; and the sealing assembly is arranged towards the rotating shaft.

As the improvement of the present disclosure, the at least two sealing assemblies are respectively located on two sides of an axial line where the rotating shaft is located.

As the improvement of the present disclosure, the door plate main body is provided with two rotating arc surfaces close to the rotating shaft; and the two rotating arc surfaces are symmetrically arranged on two sides of the rotating shaft.

As the improvement of the present disclosure, the two panels are both provided with windows; the two windows are arranged opposite to each other; and transparent or semi-transparent shutters are arranged at the windows.

The present disclosure has the following beneficial effects. By the arrangement of the above structure, the sealing assemblies extend along the surfaces of the upper end surface, the lower end surface, the left end surface, and the right end surface of a door plate. The sealing assemblies form a sealing barrier protruding out of the end surfaces. During use, when the sealing door is closed, and free ends of the sealing assemblies are in contact with the inner surface of the door frame, and the first isolation space is formed between the two adjacent sealing assemblies and the inner surface of the door frame. The isolation space is filled with air. As the air has low thermal conductivity, thermal insulation can be effectively achieved, and the insulation effect is good. Meanwhile, the sealing assemblies arranged in multiple layers can better achieve the sealing property, so that the product has a stable structure and a good sealing effect, and can effectively block impurities such as dust and ensure the cleanliness inside the door. The product has a simple structure and good sealing and insulation effect.

### BRIEF DESCRIPTION OF DRAWINGS

In order to explain the technical solutions of the embodiments of the present disclosure more clearly, the following will briefly introduce the accompanying drawings used in the embodiments. The drawings in the following description are only some embodiments of the present disclosure. Those of ordinary skill in the art can obtain other drawings based on these drawings without creative work.

The present disclosure is further described below in detail in combination with the accompanying drawings and embodiments.

FIG. 1 is a schematic diagram of an entire structure in an angle of a sealing door according to the present disclosure;

FIG. 2 is a schematic diagram of an entire structure in another angle of a sealing door according to the present disclosure;

FIG. 3 is a schematic diagram of an exploded structure of a sealing door according to the present disclosure;

FIG. 4 is a front view of a sealing door according to the present disclosure;

FIG. 5 is a front view of a mounting state of a sealing door according to the present disclosure;

FIG. 6 is a first cross-sectional view of a sealing door according to the present disclosure;

FIG. 7 is an enlarged view of circle A in FIG. 6;

FIG. 8 is a second cross-sectional view of a sealing door according to the present disclosure;

FIG. 9 is an enlarged view of circle B in FIG. 8; and

FIG. 10 is a cross-sectional view of a mounting state of a sealing door according to the present disclosure.

### DETAILED DESCRIPTION OF THE INVENTION

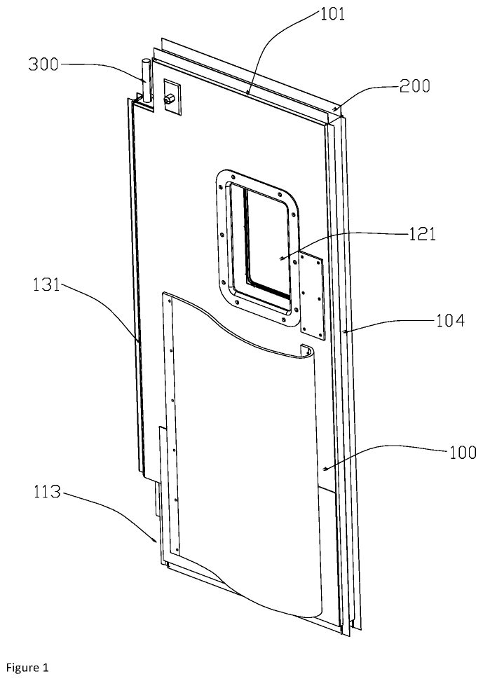

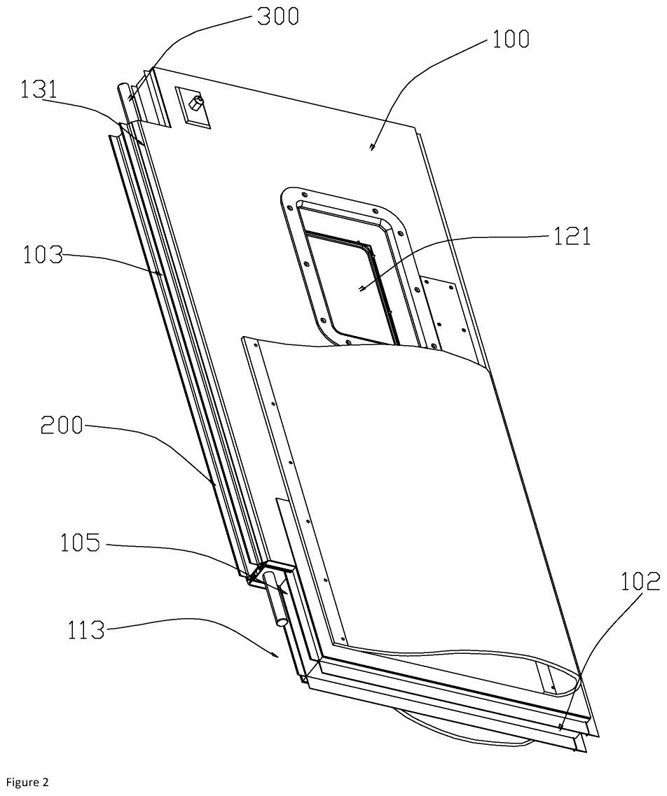

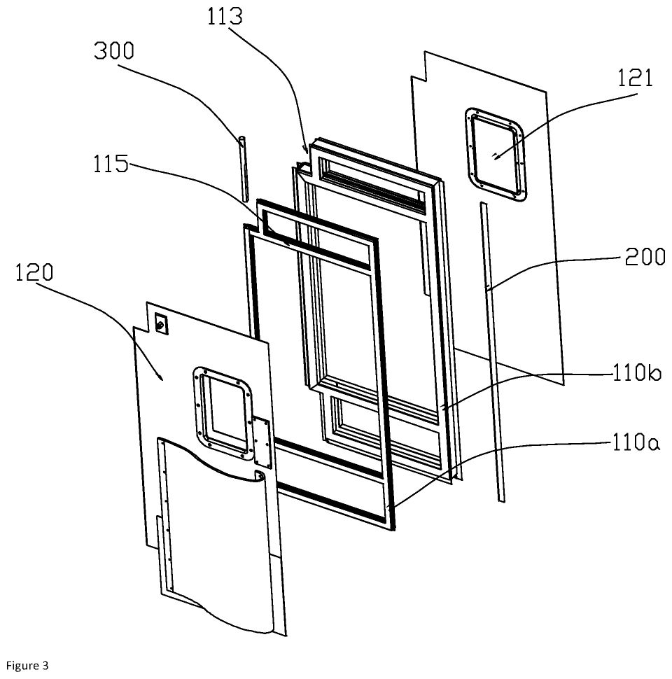

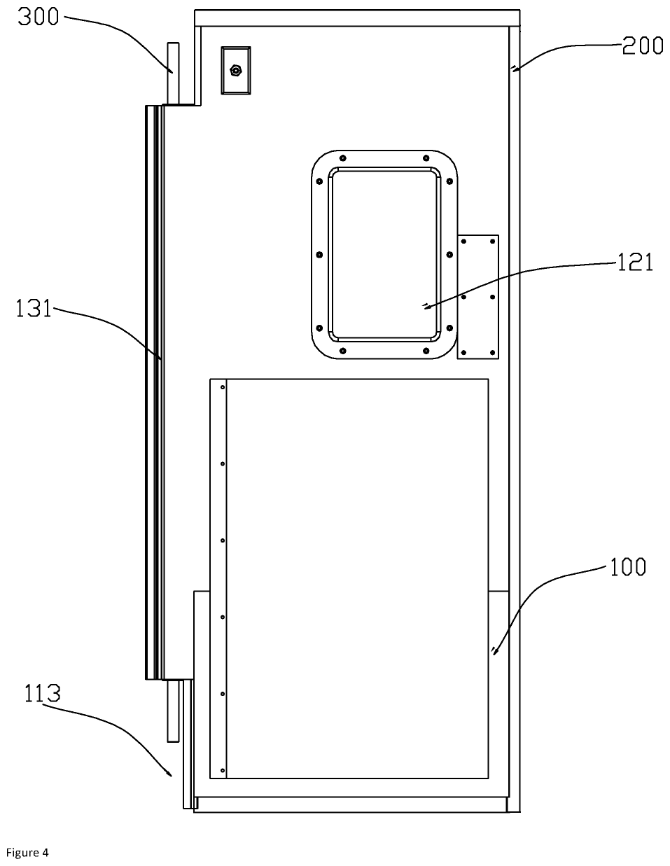

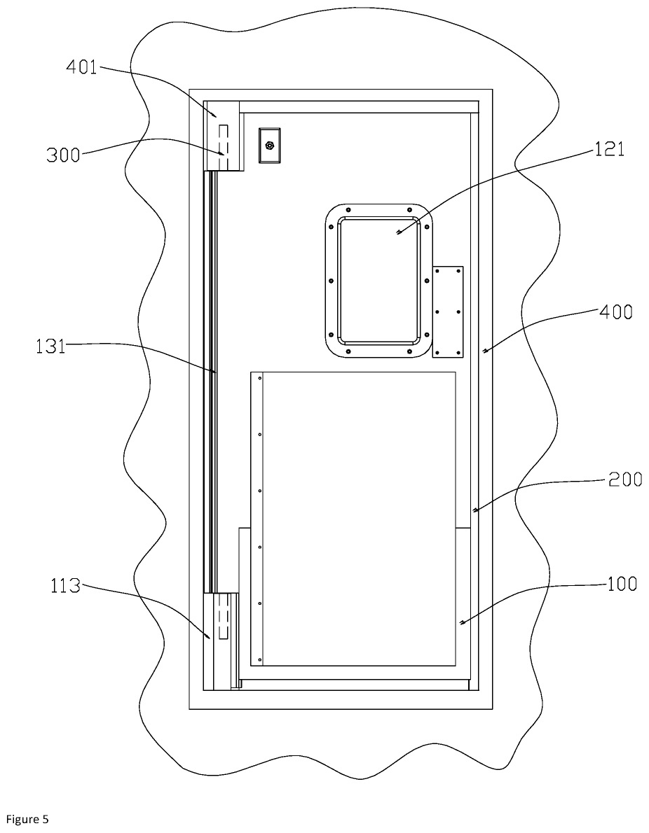

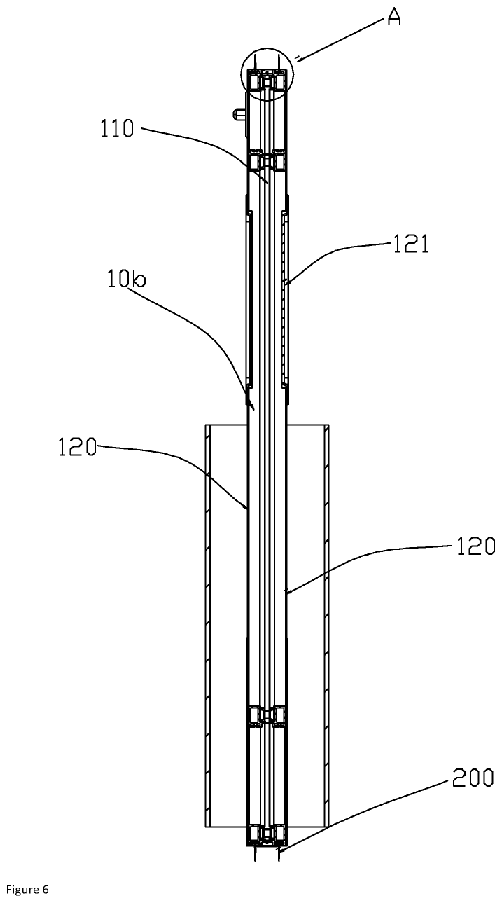

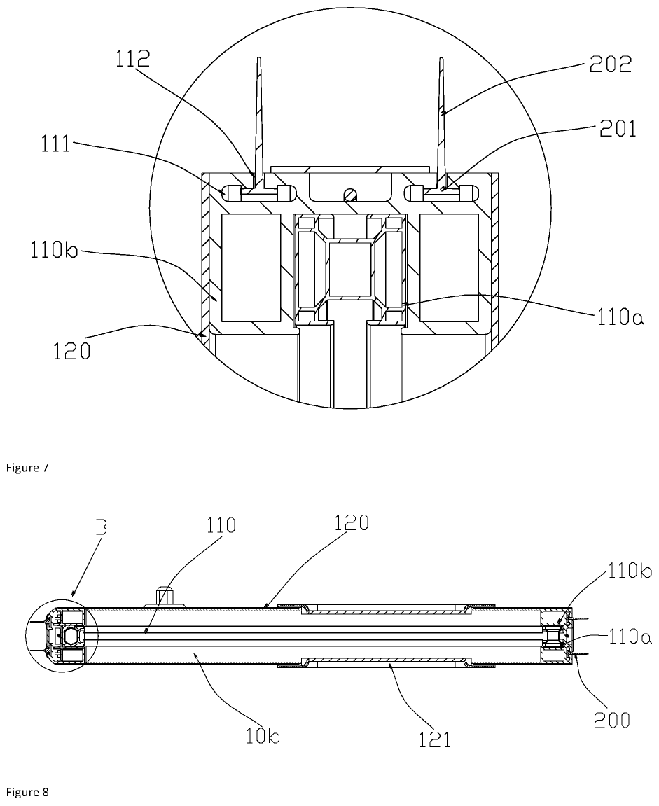

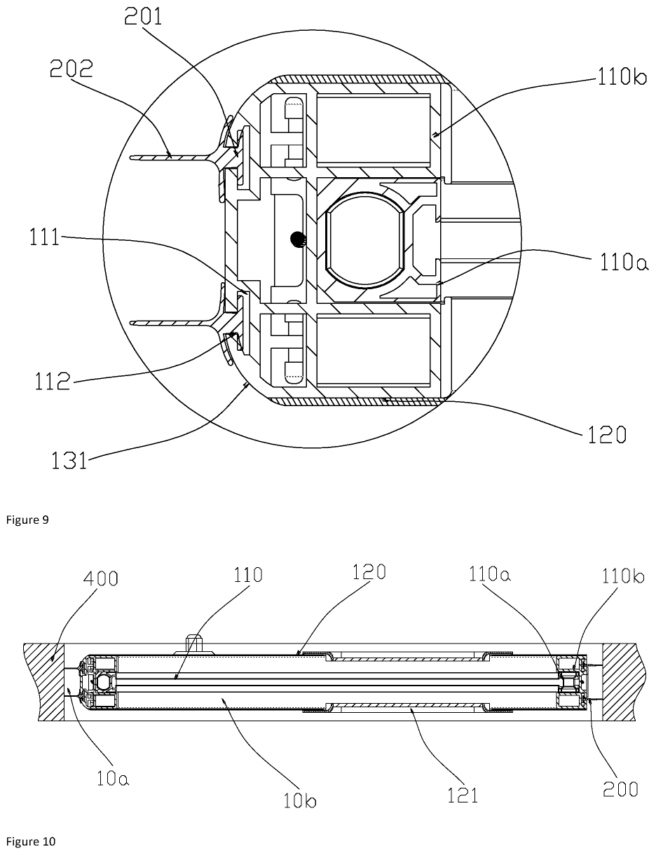

Referring to FIG. 1 to FIG. 10, a sealing door includes:
a door plate main body 100, wherein the door plate main body 100 has an upper end surface 101, a lower end surface 102, a left end surface 103, and a right end surface 104; and
at least two sealing assemblies 200, wherein the sealing assemblies 200 are arranged along surfaces of the upper end surface 101, the lower end surface 102, the left end surface 103, and the right end surface 104 in an extending manner and protrude out of the surfaces of the upper end surface 101, the lower end surface 102, the left end surface 103, and the right end surface 104; two adjacent sealing assemblies 200 are spaced apart from each other; the sealing assemblies 200 are configured to be in contact with an inner surface of a door frame when the sealing door is in a closed state, so as to form a first isolation space 10a between the two adjacent sealing assemblies 200 and the inner surface of the door frame.

By the arrangement of the above structure, the sealing assemblies 200 extend along the surfaces of the upper end surface 101, the lower end surface 102, the left end surface 103, and the right end surface 104 of a door plate. The sealing assemblies 200 form a sealing barrier protruding out of the end surfaces. During use, when the sealing door is closed, and free ends of the sealing assemblies 200 are in contact with the inner surface of the door frame, and the first isolation space 10a is formed between the two adjacent sealing assemblies 200 and the inner surface of the door frame. The isolation space is filled with air. As the air has low thermal conductivity, thermal insulation can be effectively achieved, and the insulation effect is good. Meanwhile, the sealing assemblies arranged in multiple layers can better achieve the sealing property, so that the product has a stable structure and a good sealing effect, and can effectively block impurities such as dust and ensure the cleanliness inside the door. The product has a simple structure and good sealing and insulation effect.

In this embodiment, each sealing assembly 200 is provided with a mounting part 201 and a sealing part 202; the upper end surface 101, the lower end surface 102, the left end surface 103, and the right end surface 104 are all provided with a mounting slot 111 and an open slot 112 communicated to the mounting slot 111; the mounting part 201 is inserted into the mounting slot 111; and the sealing part 202 penetrates through the open slot 112. By the arrangement of the above structure, during assembling, the mounting part 201 is inserted into the mounting slot 111, and the sealing part 202 penetrates through the open slot 112. The mounting slot 111 can effectively fix the mounting part 201 to prevent the sealing assembly 200 from falling off during opening or closing of the sealing door, which further improves the stability of the product. The sealing part 202 that penetrates through the open slot 112 protrudes out of the end surfaces. When the door plate is in the closed state, a tail end of the sealing part 202 is in contact with the inner surface of the door frame. When the end surfaces of the door plate main body are in interference covering fit with and the inner surface of the door frame, sealing is effectively achieved. Preferably, the sealing assembly is a rubber strip, which has good elasticity and wear resistance. The good elasticity can ensure that the tail end of the rubber strip is always in contact with the inner surface of the door frame under the action of an elastic reset force, which improves the sealing property of the product. The good wear resistance can prolong the service life of the product and prevent problems such as a decrease in the sealing property caused by the wear of the sealing assembly.

In this embodiment, a width of the mounting part 201 is greater than a width of the sealing part 202, and the width of the mounting part 201 is greater than a width of the open slot 112; the width of the open slot 112 is greater than the width of the sealing part 202; and the mounting part 201 abuts against an inner surface of the mounting slot 111. By the arrangement of the above structure, during use, the width of the mounting part 201 is greater than the width of the open slot 112, which can limit the mounting part 201 to the mounting slot 111, prevent the mounting part 201 from being separated from the mounting slot 111, and improve the stability of the product. The width of the open slot 112 is greater than the width of the sealing part 202, which can allow the sealing part 202 to penetrate through the open slot, so that the tail end of the sealing part 202 can be in contact with the inner surface of the door frame. Preferably, a cross section of the sealing assembly 200 is “T”-shaped. The “T”-shaped structure is more convenient to mount and more stable in connection.

In this embodiment, the door plate main body 100 includes a frame 110 and two panels 120; the two panels 120 are respectively connected to front and rear surfaces of the frame 110; and a second isolation space 10b is formed between the two panels 120 and an inner surface of the frame 110. By the arrangement of the above structure, during use, the two panels 120 are connected to the front and rear surfaces of the frame 110, thus forming a whole. The second isolation space 10b formed between the two panels 120 and the inner surface of the frame 110 is filled with air. The air has low thermal conductivity, which can further improve the thermal insulation effect of the door plate. Meanwhile, the hollow door plate main body 100 can also reduce the weight of the sealing door, making it convenient for a user to use the product. Preferably, reinforcement rods 115 are further arranged at intervals in a lengthwise direction of the frame 110. The reinforcement rods 115 can improve the strength of the product and prolong the service life of the product. Preferably, the frame further includes an inner frame 110a and an outer frame 110b; a mounting space is arranged inside the outer frame 110b; and the inner frame 110a is inserted inside the outer frame 110b. This can effectively improve the strength of the frame 110, so that the product is less prone to deformation under a stress, and the service life of the product is prolonged.

In this embodiment, the sealing door further includes a rotating connector 300; the rotating connector 300 is arranged on one side of the door plate main body 100 close to the left end surface 103 or the right end surface 104; and the rotating connector 300 is configured to be connected to another rotating connector arranged on the inner surface of the door frame. By the arrangement of the above structure, the rotating connector is arranged on a left or right side of the door plate main body 100, and the rotating connector is connected to another rotating connector 401 on the inner surface of the door frame 400, which can achieve rotatable connection between the door plate main body 100 and a mounting position such as the door frame.

In this embodiment, the rotating connector 300 is a rotating shaft; notches 113 are arranged at upper and lower ends of the left end surface 103 or upper and lower ends of the right end surface 104; and the rotating shaft is arranged inside the notches 113. The rotating shaft is arranged inside the notches 113 to avoid a tail end of the rotating shaft from protruding out of the end surfaces of the door plate main body 100, so that a length of the product is the same as a distance between the upper end surface and lower end surface of the door plate main body 100, and/or a width of the product is the same as a distance between the left end surface and right end surface of the door plate main body 100, making it convenient for product transportation. Meanwhile, during the mounting of the product, the notches 113 can also avoid a wall surface where the door frame is located, making it convenient for the user to insert the rotating shaft into a rotating hole or a rotating bearing and to mount the product. Preferably, a mounting hole is formed in the middle of the inner frame 110a, and a connecting end of the rotating shaft is inserted into the mounting hole of the inner frame 110a close to the notches 113, which can achieve stable connection between the rotating shaft and the frame 110.

In this embodiment, each notch 113 has a side end surface 105; at least a part of each sealing assembly 200 is arranged on the side end surface 105; and the sealing assembly 200 is arranged towards the rotating shaft. By the arrangement of the above structure, a part of each sealing assembly 200 is arranged on the side end surface 105, which can make the rotating connector 300, such as a bearing, on the inner surface of the door frame be in contact with the tail end of the sealing assembly 200, so that the sealing property at the rotating shaft is improved, and the sealing property and thermal insulation property of the product are further ensured.

In this embodiment, the at least two sealing assemblies 200 are respectively located on two sides of an axial line where the rotating shaft is located. By the arrangement of the above structure, the partial structures of the two sealing assemblies 200 are located on the two sides of the axial line where the rotating shaft is located. The tail ends of the sealing parts 202 of the sealing assemblies 200 are in contact with a surface of the rotating connector 300 such as a bearing, thus forming an air isolation layer between the two sealing assemblies 200 and the surface of the rotating connector 300 such as a bearing, which further improves the thermal insulation property of the product.

In this embodiment, the door plate main body 100 is provided with two rotating arc surfaces 131 close to the rotating shaft; and the two rotating arc surfaces 131 are symmetrically arranged on two sides of the rotating shaft. By the arrangement of the above structure, when the door plate main body 100 rotates relative to a mounting main body such as the door frame, the rotating arc surfaces 131 can provide an avoidance space, so that the door plate main body 100 rotates smoothly relative to the mounting main body such as the door frame. This prevents an edge of the door plate main body 100 from scratching the inner surface of the door frame and improves the user experience.

In this embodiment, the two panels 120 are both provided with windows 121; the two windows 121 are arranged opposite to each other; and transparent or semi-transparent shutters are arranged at the windows 121. By the arrangement of the above structure, arranging the windows 121 and using the transparent or semi-transparent shutters to cover the windows 121 can facilitate the user to observe the environments inside and outside the door through the windows and also allow light to pass through the windows 121.

Referring to FIG. 1 to FIG. 10, a sealing method includes: providing a sealing door, and mounting the sealing door in a door frame. The sealing door includes:
a door plate main body 100, wherein the door plate main body 100 has an upper end surface 101, a lower end surface 102, a left end surface 103, and a right end surface 104; and
at least two sealing assemblies 200, wherein the sealing assemblies 200 are arranged along surfaces of the upper end surface 101, the lower end surface 102, the left end surface 103, and the right end surface 104 in an extending manner and protrude out of the surfaces of the upper end surface 101, the lower end surface 102, the left end surface 103, and the right end surface 104; two adjacent sealing assemblies 200 are spaced apart from each other; when the sealing door is closed, the sealing assemblies 200 are in contact with an inner surface of the door frame, so as to form a first isolation space 10a between the two adjacent sealing assemblies 200 and the inner surface of the door frame.

According to the sealing door, the sealing assemblies 200 extend along the surfaces of the upper end surface 101, the lower end surface 102, the left end surface 103, and the right end surface 104 of a door plate. The sealing assemblies 200 form a sealing barrier protruding out of the end surfaces. During use, when the sealing door is closed, and free ends of the sealing assemblies 200 are in contact with the inner surface of the door frame, and the first isolation space 10a is formed between the two adjacent sealing assemblies 200 and the inner surface of the door frame. The isolation space is filled with air. As the air has low thermal conductivity efficiency, thermal insulation can be effectively achieved, and the insulation effect is good. Meanwhile, the sealing assemblies arranged in multiple layers can better achieve the sealing property, so that the product has a stable structure and a good sealing effect, and can effectively block impurities such as dust and ensure the cleanliness inside the door. The product has a simple structure and good sealing and insulation effect.

In this embodiment, each sealing assembly 200 is provided with a mounting part 201 and a sealing part 202; the upper end surface 101, the lower end surface 102, the left end surface 103, and the right end surface 104 are all provided with a mounting slot 111 and an open slot 112 communicated to the mounting slot 111; the mounting part 201 is inserted into the mounting slot 111; and the sealing part 202 penetrates through the open slot 112. By the arrangement of the above structure, during assembling, the mounting part 201 is inserted into the mounting slot 111, and the sealing part 202 penetrates through the open slot 112. The mounting slot 111 can effectively fix the mounting part 201 to prevent the sealing assembly 200 from falling off during opening or closing of the sealing door, which further improves the stability of the product. The sealing part 202 that penetrates through the open slot 112 protrudes out of the end surfaces. When the door plate is in the closed state, a tail end of the sealing part 202 is in contact with the inner surface of the door frame. When the end surfaces of the door plate are in interference covering fit with and the inner surface of the door frame, sealing is effectively achieved. Preferably, the sealing assembly is a rubber strip, which has good elasticity and wear resistance. The good elasticity can ensure that the tail end of the rubber strip is always in contact with the inner surface of the door frame under the action of an elastic reset force, which improves the sealing property of the product. The good wear resistance can prolong the service life of the product and prevent problems such as a decrease in the sealing property caused by the wear of the sealing assembly.

In this embodiment, a width of the mounting part 201 is greater than a width of the sealing part 202, and the width of the mounting part 201 is greater than a width of the open slot 112; the width of the open slot 112 is greater than the width of the sealing part 202; and the mounting part 201 abuts against an inner surface of the mounting slot 111. By the arrangement of the above structure, during use, the width of the mounting part 201 is greater than the width of the open slot 112, which can limit the mounting part 201 to the mounting slot 111, prevent the mounting part 201 from being separated from the mounting slot 111, and improve the stability of the product. The width of the open slot 112 is greater than the width of the sealing part 202, which can allow the sealing part 202 to penetrate through the open slot, so that the tail end of the sealing part 202 can be in contact with the inner surface of the door frame. Preferably, a cross section of the sealing assembly 200 is “T”-shaped. The “T”-shaped structure is more convenient to mount and more stable in connection.

In this embodiment, the door plate main body 100 includes a frame 110 and two panels 120; the two panels 120 are respectively connected to front and rear surfaces of the frame 110; and a second isolation space 10b is formed between the two panels 120 and an inner surface of the frame 110. By the arrangement of the above structure, during use, the two panels 120 are connected to the front and rear surfaces of the frame 110, thus forming a whole. The second isolation space 10b formed between the two panels 120 and the inner surface of the frame 110 is filled with air. The air has low thermal conductivity, which can further improve the thermal insulation effect of the door plate. Meanwhile, the hollow door plate main body 100 can also reduce the weight of the sealing door, making it convenient for a user to use the product. Preferably, reinforcement rods 115 are further arranged at intervals in a lengthwise direction of the frame 110. The reinforcement rods 115 can improve the strength of the product and prolong the service life of the product. Preferably, the frame further includes an inner frame 110a and an outer frame 110b; a mounting space is arranged inside the outer frame 110b; and the inner frame 110a is inserted inside the outer frame 110b. This can effectively improve the strength of the frame 110, so that the product is less prone to deformation under a stress, and the service life of the product is prolonged.

In this embodiment, the sealing door further includes a rotating connector 300; the rotating connector 300 is arranged on one side of the door plate main body 100 close to the left end surface 103 or the right end surface 104; and the rotating connector 300 is configured to be connected to another rotating connector arranged on the inner surface of the door frame. By the arrangement of the above structure, the rotating connector is arranged on a left or right side of the door plate main body 100, and the rotating connector is connected to another rotating connector 401 on the inner surface of the door frame 400, which can achieve rotatable connection between the door plate main body 100 and a mounting position such as the door frame 400.

In this embodiment, the rotating connector 300 is a rotating shaft; notches 113 are arranged at upper and lower ends of the left end surface 103 or upper and lower ends of the right end surface 104; and the rotating shaft is arranged inside the notches 113. The rotating shaft is arranged inside the notches 113 to avoid a tail end of the rotating shaft from protruding out of the end surfaces of the door plate main body 100, so that a length of the product is the same as a distance between the upper end surface and lower end surface of the door plate main body 100, and/or a width of the product is the same as a distance between the left end surface and right end surface of the door plate main body 100, making it convenient for product transportation. Meanwhile, during the mounting of the product, the notches 113 can also avoid a wall surface where the door frame is located, making it convenient for the user to insert the rotating shaft into a rotating hole or a rotating bearing and to mount the product. Preferably, a mounting hole is formed in the middle of the inner frame 110a, and a connecting end of the rotating shaft is inserted into the mounting hole of the inner frame 110a close to the notches 113, which can achieve stable connection between the rotating shaft and the frame 110.

In this embodiment, each notch 113 has a side end surface 105; at least a part of each sealing assembly 200 is arranged on the side end surface 105; and the sealing assembly 200 is arranged towards the rotating shaft. By the arrangement of the above structure, a part of each sealing assembly 200 is arranged on the side end surface 105, which can make the rotating connector 300, such as a bearing, on the inner surface of the door frame 400 be in contact with the tail end of the sealing assembly 200, so that the sealing property at the rotating shaft is improved, and the sealing property and thermal insulation property of the product are further ensured.

In this embodiment, the at least two sealing assemblies 200 are respectively located on two sides of an axial line where the rotating shaft is located. By the arrangement of the above structure, the partial structures of the two sealing assemblies 200 are located on the two sides of the axial line where the rotating shaft is located. The tail ends of the sealing parts 202 of the sealing assemblies 200 are in contact with a surface of the rotating connector 300 such as a bearing, thus forming an air isolation layer between the two sealing assemblies 200 and the surface of the rotating connector 300 such as a bearing, which further improves the thermal insulation property of the product.

In this embodiment, the door plate main body 100 is provided with two rotating arc surfaces 131 close to the rotating shaft; and the two rotating arc surfaces 131 are symmetrically arranged on two sides of the rotating shaft. By the arrangement of the above structure, when the door plate main body 100 rotates relative to a mounting main body such as the door frame, the rotating arc surfaces 131 can provide an avoidance space, so that the door plate main body 100 rotates smoothly relative to the mounting main body such as the door frame. This prevents an edge of the door plate main body 100 from scratching the inner surface of the door frame and improves the user experience.

In this embodiment, the two panels 120 are both provided with windows 121; the two windows 121 are arranged opposite to each other; and transparent or semi-transparent shutters are arranged at the windows 121. By the arrangement of the above structure, arranging the windows 121 and using the transparent or semi-transparent shutters to cover the windows 121 can facilitate the user to observe the environments inside and outside the door through the windows and also allow light to pass through the windows 121.

One or more implementation modes are provided above in combination with specific contents, and it is not deemed that the specific implementation of the present disclosure is limited to these specifications. Any technical deductions or replacements approximate or similar to the method and structure of the present disclosure or made under the concept of the present disclosure shall fall within the scope of protection of the present disclosure.

1. A sealing door, comprising:
a door plate main body, wherein the door plate main body has an upper end surface, a lower end surface, a left end surface, and a right end surface; and
at least two sealing assemblies, wherein the sealing assemblies are arranged along surfaces of the upper end surface, the lower end surface, the left end surface, and the right end surface in an extending manner and protrude out of the surfaces of the upper end surface, the lower end surface, the left end surface, and the right end surface; two adjacent sealing assemblies are spaced apart from each other; the sealing assemblies are configured to be in contact with an inner surface of a door frame when the sealing door is in a closed state, so as to form a first isolation space between the two adjacent sealing assemblies and the inner surface of the door frame.

2. The sealing door according to claim 1, wherein each sealing assembly is provided with a mounting part and a sealing part; the upper end surface, the lower end surface, the left end surface, and the right end surface are all provided with a mounting slot and an open slot communicated to the mounting slot; the mounting part is inserted into the mounting slot; and the sealing part penetrates through the open slot.

3. The sealing door according to claim 2, wherein a width of the mounting part is greater than a width of the sealing part, and the width of the mounting part is greater than a width of the open slot; the width of the open slot is greater than the width of the sealing part; and the mounting part abuts against an inner surface of the mounting slot.

4. The sealing door according to claim 1, wherein the door plate main body comprises a frame and two panels; the two panels are respectively connected to front and rear surfaces of the frame; and a second isolation space is formed between the two panels and an inner surface of the frame.

5. The sealing door according to claim 1, further comprising a rotating connector, wherein the rotating connector is arranged on one side of the door plate main body close to the left end surface or the right end surface; and the rotating connector is configured to be connected to another rotating connector arranged on the inner surface of the door frame.

6. The sealing door according to claim 5, wherein the rotating connector is a rotating shaft; notches are arranged at upper and lower ends of the left end surface or upper and lower ends of the right end surface; and the rotating shaft is arranged inside the notches.

7. The sealing door according to claim 6, wherein each notch has a side end surface; at least a part of each sealing assembly is arranged on the side end surface; and the sealing assembly is arranged towards the rotating shaft.

8. The sealing door according to claim 7, wherein the at least two sealing assemblies are respectively located on two sides of an axial line where the rotating shaft is located.

9. The sealing door according to claim 6, wherein the door plate main body is provided with two rotating arc surfaces close to the rotating shaft; and the two rotating arc surfaces are symmetrically arranged on two sides of the rotating shaft.

10. The sealing door according to claim 4, wherein the two panels are both provided with windows; the two windows are arranged opposite to each other; and transparent or semi-transparent shutters are arranged at the windows.

11. A sealing method, comprising: providing a sealing door, and mounting the sealing door in a door frame, wherein the sealing door comprises:
a door plate main body, wherein the door plate main body has an upper end surface, a lower end surface, a left end surface, and a right end surface; and
at least two sealing assemblies, wherein the sealing assemblies are arranged along surfaces of the upper end surface, the lower end surface, the left end surface, and the right end surface in an extending manner and protrude out of the surfaces of the upper end surface, the lower end surface, the left end surface, and the right end surface; two adjacent sealing assemblies are spaced apart from each other; when the sealing door is closed, the sealing assemblies are in contact with an inner surface of the door frame, so as to form a first isolation space between the two adjacent sealing assemblies and the inner surface of the door frame.

12. The sealing method according to claim 11, wherein each sealing assembly is provided with a mounting part and a sealing part; the upper end surface, the lower end surface, the left end surface, and the right end surface are all provided with a mounting slot and an open slot communicated to the mounting slot; the mounting part is inserted into the mounting slot; and the sealing part penetrates through the open slot.

13. The sealing method according to claim 12, wherein a width of the mounting part is greater than a width of the sealing part, and the width of the mounting part is greater than a width of the open slot; the width of the open slot is greater than the width of the sealing part; and the mounting part abuts against an inner surface of the mounting slot.

14. The sealing method according to claim 11, wherein the door plate main body comprises a frame and two panels; the two panels are respectively connected to front and rear surfaces of the frame; and a second isolation space is formed between the two panels and an inner surface of the frame.

15. The sealing method according to claim 11, wherein the sealing door further comprises a rotating connector; the rotating connector is arranged on one side of the door plate main body close to the left end surface or the right end surface; and the rotating connector is configured to be connected to another rotating connector arranged on the inner surface of the door frame.

16. The sealing method according to claim 15, wherein the rotating connector is a rotating shaft; notches are arranged at upper and lower ends of the left end surface or upper and lower ends of the right end surface; and the rotating shaft is arranged inside the notches.

17. The sealing method according to claim 16, wherein each notch has a side end surface; at least a part of each sealing assembly is arranged on the side end surface; and the sealing assembly is arranged towards the rotating shaft.

18. The sealing method according to claim 17, wherein the at least two sealing assemblies are respectively located on two sides of an axial line where the rotating shaft is located.

19. The sealing method according to claim 16, wherein the door plate main body is provided with two rotating arc surfaces close to the rotating shaft; and the two rotating arc surfaces are symmetrically arranged on two sides of the rotating shaft.

20. The sealing method according to claim 14, wherein the two panels are both provided with windows; the two windows are arranged opposite to each other; and transparent or semi-transparent shutters are arranged at the windows.
